(19) United States
(12) Patent Application Publication
(10) Pub. No.: US 2021/0283800 A1
(43) Pub. Date: Sep. 16, 2021

(54) TREATED POROUS MATERIAL

(71) Applicant: Dow Global Technologies, LLC, Midland, MI (US)

(72) Inventors: Xue Chen, Manvel, TX (US); Stephen W. King, League City, TX (US)

(21) Appl. No.: 16/334,592

(22) PCT Filed: Sep. 28, 2017
(86) PCT No.: PCT/US2017/054012

§ 371 Date: Mar. 19, 2019

Related U.S. Application Data
(60) Provisional application No. 62/401,978, filed on Sep. 30, 2016.

(51) Int. Cl. B27K 3/15; B27K 3/36; C09D 171/02; C09D 167/08; C09D 167/00; C09D 175/04; C09D 101/28

(52) U.S. Cl. CPC B27K 3/15; B27K 3/36; C09D 171/02; C09D 101/28; C09D 167/00; C09D 175/04; C09D 167/08

(57) ABSTRACT

A treated cellulosic material comprising: a cellulosic material having a porous structure defining a plurality of pores, the cellulosic material comprising wood including wood or wood composite materials, at least a portion of the pores containing a treating agent comprising: a polymer comprising a water soluble polyol; and a modifying agent comprising a hydrophobic polymer. A method for preparing a treated cellulosic material comprising: providing a cellulosic material; a first treatment protocol comprising impregnating the cellulosic material with a solution comprising a polymer, the polymer comprising a water soluble polyol; and a second treatment protocol comprising impregnating the cellulosic material with a modifying agent, the modifying agent comprising a hydrophobic polymer dispersed in an aqueous dispersion.

### BACKGROUND

Porous materials, such as cellulosic materials, need to be protected from insect attack, rot and water impregnation to help preserve the physical properties of the cellulosic material. One example of such a cellulosic material is wood. A variety of treatment agents and preservation methods are known to preserve cellulosic materials.

Modern preservation methods typically involve pressure treating the cellulosic material with a treating agent. Pressure treatment typically allows the treating agent to penetrate throughout the porous structure of the cellulosic material. The treating agent is typically a chemical compound selected to impart the desired physical properties to the cellulosic material. For example, treating agents that increase hardness, add water resistance and improve the dimensional stability of the cellulosic material are of interest. Wood is capable of absorbing as much as 100% of its weight in water which causes the wood to swell, which after loss of water through evaporation causes the wood to shrink. This process of water absorption/evaporation is non-uniform and creates internal stresses in the wood leading to splitting, warping, bowing, crooking, twisting, cupping, etc. Also, water can serve as a pathway for organisms that degrade the cellulosic material, such as insects or fungus. Treating agents that repel insects, or minimize the formation of fungi, or improve the overall durability of the cellulosic material are of interest. Further, treating agents can improve wind resistance, ultraviolet radiation resistance, stability at high and low temperatures, pest resistance, fire resistance and other issues which might affect the physical properties of the cellulosic material.

An improved treating agent for cellulosic materials is desired.

### SUMMARY

A treated cellulosic material comprising: a cellulosic material having a porous structure defining a plurality of pores, the cellulosic material comprising wood including wood or wood composite materials, at least a portion of the pores containing a treating agent comprising: a polymer comprising a water soluble polyol; and a modifying agent comprising a hydrophobic polymer.

A method for preparing a treated cellulosic material comprising: providing a cellulosic material; a first treatment protocol comprising impregnating the cellulosic material with a solution comprising a polymer, the polymer comprising a water soluble polyol; and a second treatment protocol comprising impregnating the cellulosic material with a modifying agent, the modifying agent comprising a hydrophobic polymer dispersed in an aqueous dispersion.

### DETAILED DESCRIPTION

As used herein, the term “porous material” refers to a material which is permeable such that fluids are movable therethrough by way of pores or other passages. An example of a porous material is a cellulosic material. Other examples of porous materials include stone, concrete, ceramics, and derivatives thereof. As used herein, the term “cellulosic material” refers to a material that includes cellulose as a structural component. Examples of cellulosic materials include wood, paper, textiles, rope, particleboard and other biologic and synthetic materials. As used herein, wood includes solid wood and all wood composite materials (e.g., chipboard, engineered wood products, etc.). Cellulosic materials generally have a porous structure that defines a plurality of pores.

As used herein, unless otherwise indicated, the phrase “molecular weight” refers to the weight average molecular weight.

A “treated cellulosic material” is a cellulosic material that has been treated with a treating agent to modify the properties of the cellulosic material. The properties modified by the treating agent include, but are not limited to, increased hydrophobicity, dimensional stability, fungi resistance, insect resistance, hardness, surface appearance, UV stability, fire resistance, and coatability. Increasing the hydrophobicity of a cellulosic material can provide other ancillary benefits, such as dimensional stability, by reducing the rate of water adsorption and evaporation, thus reducing the internal stresses of expanding and contracting.

A “treating agent” is a substance that, when combined with the cellulosic material, modifies the properties of the cellulosic material. In one instance, the treating agent comprises both a polymer and a modifying agent. The treating agent is applied to the cellulosic material. One method of applying the treating agent to the cellulosic material is through impregnation using pressure treatment. In one instance, the polymer is applied to the cellulosic material as part of a solution. Other methods of applying the treating agent are known, such as brushing, spraying, dipping, soaking and extrusion. Once applied, a significant amount of the treating agent will permeate the surface of the cellulosic material.

As used herein, the use of the term “(meth)” followed by another term such as acrylate refers to both acrylates and methacrylates. For example, the term “(meth)acrylate” refers to either acrylate or methacrylate; the term “(meth)acrylic” refers to either acrylic or methacrylic; and the term “(meth)acrylic acid” refers to either acrylic acid or methacrylic acid.

As used herein, polymer refers to a molecule that is formed from one or more types of monomers.

In one instance, the polymer comprises a water-soluble polyol. As used herein, “water-soluble” means that the solution has at least 10 wt % of polyol in water without phase separation, precipitation, or solid residue. In one instance, the water-soluble polyol is a polymer having 2 or more hydroxyl groups. Examples of water-soluble polyols include, polyethylene glycol, polyvinyl alcohol, ethylene oxide/propylene oxide copolymer, ethoxylated glycerin, ethoxylated trimethylolpropane or ethoxylated sugars. In one instance, the water-soluble polyol is selected having a molecular weight of less than 10000. In one instance, the water-soluble polyol is selected having a molecular weight of less than 2000. In one instance, the water-soluble polyol is selected having a molecular weight of less than 1500. In one instance, the water-soluble polyol is selected having a molecular weight of at least 300. In one instance, a polyethylene glycol is selected having a molecular weight of less than 1000. CARBOWAX™ Polyethylene Glycol 1000 (The Dow Chemical Company) is an example of a commercially available polyethylene glycol. In the case of copolymers, it can be random, block, or a graft copolymer. As used herein, copolymer refers to a polymer formed by uniting two or more monomers. Examples of copolymers include bipolymers, terpolymers, tetrapolymers, and other higher-ordered copolymers.

In one instance, the polymer is a constituent part of an aqueous solution. In one instance, the solution is a medium that comprises the polymer, water, and optionally an organic solvent. The polymer solution is prepared such that the viscosity of the water-soluble polymer solution is suitable for penetrating the pores of the cellulosic material for distribution through the cellulosic material. In one instance, the viscosity of the solution is from 10 cP to 5000 cP at ambient temperature. In one instance, the viscosity of the solution is less than 500 cP at ambient temperature. In one instance, the water-soluble polymer solution also comprises one or more additives. In one instance, the polymer content of the solution is 1 to 75 weight percent. In one instance, the polymer content of the solution is 5 to 60 weight percent. In one instance, the polymer content of the solution is 10 to 55 weight percent. In one instance, the polymer content of the solution is 15 to 50 weight percent. In one instance, the polymer content of the solution is 25 to 45 weight percent. In one instance, the polymer content of the solution is 30 to 40 weight percent. In one instance the solution includes a solvent, for example, an organic solvent such as an oxygenated solvent, a hydrocarbon solvent, a halogenated solvent, or a combination thereof.

The modifying agent is a substance that, when added to the porous material, improves the properties of the porous material. In one instance, the modifying agent is a hydrophobic polymer. In one instance the hydrophobic polymer is modified cellulose polymer, polyolefin, water-soluble polyol, polyurethane, alkyd, polyester or mixture thereof. In one instance, the modified cellulose polymer comprises methyl cellulose, ethyl cellulose, ethylhydroxyethyl cellulose, hydroxypropyl cellulose, hydroxypropylmethyl cellulose (also called hypromellose), methyl ethyl cellulose, carboxymethyl cellulose(CMC), sodium carboxymethyl cellulose, or cross-linked sodium carboxymethyl cellulose (also called croscarmellose sodium), cellulose gum, or cellulose gel, and their derivatives. Commercial modified cellulose polymers are suitable, such as ETHOCEL™ available from The Dow Chemical Company. In another instance, the polymer comprises a cellulose graft polymer. In order to improve the hydrophobicity of the cellulose, hydrophobic monomers such as butyl acrylate, butyl methacrylate, styrene, butadiene, isobutyl vinyl ether, or vinyl acetate can be grafted onto the surface of the cellulose. In one instance, the polyurethane polymer is a water-dispersible polyurethane. In one instance, the polyurethane polymer contains the acidic or the anionic form of dimethylolpropionic acid. In one instance, the polyurethane polymer is a thermoplastic polyurethane or a thermosetting polyurethane. In one instance, at least a portion of the polyurethane polymer is crosslinked. The polyurethane polymer can be aromatic containing or nonaromatic containing. In one instance, the polyester polymer comprises, in polymerized form, a dicarboxylic acid, a polyhydroxy compound, and, a difunctional sulfomonomer. The difunctional sulfomonomer component of the sulfopolyester preferably comprises an aromatic nucleus having at least one sulfonate group and two functional groups, selected from the groups consisting of hydroxyl, carboxyl or amino functional groups. The amino functional group may be a primary amino group or a secondary amino group. Advantageous difunctional sulfomonomer components are those wherein the sulfonate salt group is attached to an aromatic acid nucleus such as benzene, naphthalene, diphenyl, oxydiphenyl, sulfonyidiphenyl or methylenediphenyl nucleus. Preferred results are obtained through the use of sulfophthalic acid, sulfoterephthalic acid, sulfoisophthalic acid, 4-sulfonaphthalene-2,7-dicarboxylic acid, and their esters. In one instance, the difunctional sulfomonomer component is selected from the group consisting of 5-(sodiosulfo)isophthalic acid, 5-(lithiosulfo)-isophthalic acid, and the methyl esters thereof. In one instance, the dicarboxylic acid comprises one or more of saturated aliphatic dicarboxylic acids or cycloaliphatic dicarboxylic acids. In one instance, the polyhydroxy compound comprises a diol, a triol, a tetrol or a combination thereof. In one instance, the polymer comprises a (meth)acrylate polymer (also referred to herein as poly(meth)acrylate). In one instance, the poly(meth)acrylate polymer is formed using one or more monomers, for example, acrylic acid and its derivatives, including methacrylic acid, methyl acrylate, ethyl acrylate, butyl acrylate, methyl methacrylate, ethyl methacrylate, butyl methacrylate, 2-ethylhexyl acrylate, hydroxyethyl acrylate, and hydroxyethyl methacrylate. Additional unsaturated monomers such as styrene and styrene derivative monomers may be added to form poly(meth)acrylate/styrene copolymers. In one instance, the polymer comprises an alkyd. The alkyd may be derived from mono and polycarboxylic acids or anhydrides (e.g., benzoic acid, phthalic anhydride, maleic anhydride, etc.), polyols (e.g., trimethylolethane, pentaerythritol, erythritol, threitol, dipentaerythritol, sorbitol, glycerine, etc.), and a drying oil (e.g., coconut oil, fish oil, linseed oil, tung oil, castor oil, cottonseed oil, safflower oil, sunflower oil, soybean oil, canola oil, corn oil, flaxseed oil, palm oil, palm kernel oil, epoxidized soybean oil, hydrogenated castor oil, rapeseed oil, tall oil, etc.). The Alkyd resin can be drying (including semi drying) or nondrying, the alkyd may be long, medium, short, or a combination.

In one instance, the modifying agent is a constituent part of an aqueous dispersion. In one instance, the dispersion is a medium that comprises the modifying agent and water. The aqueous dispersion is prepared such that the suspended particle size in the dispersion is suitable for penetrating the pores of the cellulosic material for distribution through the cellulosic material. In one instance, the average particle size of the solids in the aqueous dispersion are less than 50 micrometers. In one instance, the average particle size of the solids in the aqueous dispersion are less than 0.5 micrometers. In one instance, the average particle size of the solids in the aqueous dispersion are greater than 0.001 micrometers. In one instance, the dispersion also comprises one or more additives. In one instance, any solids present in the aqueous dispersion are held in a stable suspension and are transportable by the dispersion into the pores of the cellulosic material. In one instance, the solid content of the dispersion is 1 to 70 weight percent. In one instance, the solid content of the dispersion is 5 to 60 weight percent. In one instance, the solid content of the dispersion is 5 to 50 weight percent. In one instance, the solid content of the dispersion is 5 to 40 weight percent. In one instance, the solid content of the dispersion is 10 to 35 weight percent. In one instance, the solid content of the dispersion is 15 to 30 weight percent. The aqueous dispersion is prepared such that the viscosity is suitable for penetrating the pores of the cellulosic material for distribution through the cellulosic material. In one instance, the viscosity of the solution is from 10 cP to 5000 cP at ambient temperature. In one instance, the viscosity of the solution is less than 500 cP at ambient temperature.

In one instance, a solvent is selected that will form a stable dispersion with both the polymer and the modifying agent to allow treatment of the porous material in a single step. In one instance the solvent contains water. In one instance the solvent is an organic solvent. In one instance the organic solvent is an oxygenated solvent, a hydrocarbon solvent, a halogenated solvent, or a combination thereof.

The treating agent is combined with the cellulosic material. In one instance, the treating agent is introduced to the cellulosic material by pressure treatment, as described herein. In another instance, the treating agent is introduced to the cellulosic material by other techniques known in the art, for example, brushing, dipping, soaking, spraying, and extrusion. The treating agent becomes impregnated in at least a portion of the pores of the cellulosic material, and thereby increases the weight of the cellulosic material. In one instance, the polymer increases the weight of the cellulosic material by 1 to 80 percent (as calculated after drying the cellulosic material). In one instance, the treating agent—the combination of the polymer and the modifying agent—increases the weight of the cellulosic material by 5 to greater than 100 percent (as calculated after drying the cellulosic material).

In one instance, the treating agent comprises one or more additives. The additive may be included as part of the water-soluble polymer solution, as part of the modifying agent, or may be included separately therefrom. Additives which are known to add properties to treated cellulosic materials are suitable, such as, flame retardants, dispersants and/or dyes. For example, the additives may be organic compounds, metallic compounds, or organometallic compounds. In one instance, the additive is a material which improves the wetting or penetration of the polymer into the wood, for example, solvents or surfactants (anionic, cationic or nonionic) that are stable in the solution. Examples of additives include, solvents, fillers, thickeners, emulsifiers, dispersing agents, buffers, pigments, penetrants, antistatic agents, odor substances, corrosion inhibitors, preservatives, siliconizing agents, rheology modifiers, anti-settling agents, anti-oxidants, other crosslinkers (e.g. diols and polyols), optical brighteners, waxes, coalescence agents, biocides and anti-foaming agents. Such fillers may include silica, Ca(OH)₂ or CaCO₃. In addition, the treating agent may be used in conjunction with wood preservatives containing, for example, cupric-ammonia, cupric-amine, cupric-ammonia-amine complexes, quaternary ammonium compounds, or other systems. For example, the treating agent may be used with Alkaline Copper-Quaternary ammonium (ACQ) preservative systems. The treating agent may also be used with wood preservative technologies which use zinc salts or boron containing compounds. Optionally, other additives such as insecticides, termiticides, and fungicides may be added to the treating agent. In one instance, one or more surfactant is added to the solution. In one instance, a surfactant is selected which reduces gelling of the polymer at the surface of the cellulosic material. In one instance, a surfactant is selected which increases the amount of polymer impregnated in the cellulosic material. For example, suitable surfactants may be nonionic, anionic, or cationic. Examples of nonionic surfactants include: alkoxylated alcohols, alkoxylated alkyl phenols, fatty acid esters, amine and amide derivatives, alkylpolyglucosides, ethylene oxide/propylene oxide copolymers, polyols and alkoxylated polyols. For example, a nonionic surfactant is TERGITOL™ L-62, commercially available from The Dow Chemical Company. Examples of anionic surfactants include: alkyl sulfates, alkyether sulfates, sulfated alkanolamides, alpha olefin sulfonates, lignosulfonates, sulfosuccinates, fatty acid salts, and phosphate esters. For example, an anionic surfactant is DOWFAX™ C10L, commercially available from the Dow Chemical Company. Examples of cationic surfactants include alkyltrimethylammonium salts.

In one instance, the cellulosic material is prepared as a treated cellulosic material by pressure treatment. The pressure used to pressure treat the cellulosic material may be either higher or lower than atmospheric pressure. In one instance, the pressure is lower than ambient pressure, for example, 0.0001 to 0.09 MPa (0.75 to 675 mmHg). In another instance, the pressure is greater than ambient pressure, for example, 0.1 to 1.7 MPa (750 to 12750 mmHg). It is envisioned that pressure treatment processes known in the art are suitable for impregnating the cellulosic material with the treating agent. The temperature for the pressure treatment may be performed at a range of temperatures, for example, from ambient to 150° C.

In one instance, the treated cellulosic material is prepared according to at least a first treatment protocol and a second treatment protocol. In one instance, the first treatment protocol comprises impregnating the cellulosic material with the polymer. The first treatment protocol comprises one or more of the following steps: (a) depositing the cellulosic material in a vessel; (b) holding the vessel at vacuum for 5 to 60 minutes; (c) introducing the polymer to the vessel; (d) pressurizing the vessel to 1.03 MPa for 5 to 60 minutes; (e) draining the excess polymer; (f) optionally removing excess polymer by vacuum and (g) air drying the cellulosic material at 20 to 60° C. for 24 to 48 hours. In one instance, the polymer is part of the solution. In one instance, step (d) is performed at ambient pressure.

In one instance, the product of the first treatment protocol is subsequently prepared according to a second treatment protocol that impregnates the cellulosic material with the modifying agent. The second treatment protocol comprises one or more of the following steps: (a) depositing the cellulosic material prepared according to the first treatment protocol in a vessel; (b) introducing the modifying agent to the vessel; (c) holding the vessel at either vacuum or increased pressure for 5 to 60 minutes; (d) optionally removing excess modifying agent by vacuum; and (e) air drying the cellulosic material at 60° C. for 24 to 48 hours. In one instance, the first treatment protocol and the second treatment protocol are combined whereby step (c) of the first treatment protocol is modified to also include the modifying agent.

The several drying steps may be performed at a range of temperatures, whereby the duration of the air drying step is proportional to the temperature. Suitable air-drying temperatures are between room temperature (roughly 20° C.) and 180° C. The drying may be performed in air, in nitrogen, or other suitable atmosphere.

In one instance, the product of the first and second treatment protocols is surface coated with a water repellant coating. An example of a suitable surface coating is polyurethane.

A water immersion test is used to determine the water repellency of the treated cellulosic material according to the American Wood Protection Association Standard E4-11 procedure (Standard Method of Testing Water Repellency of Pressure Treated Wood). The water immersion test involves first, providing both a treated wafer, comprising a treated cellulosic material prepared as described herein, and a control wafer, comprising a cellulosic material treated according to the first treatment protocol described herein except that the solution is replaced by distilled water; second, measuring the tangential dimension of both the treated wafer and the control wafer to provide an initial tangential dimension (T₁) (where the tangential dimension is perpendicular to the direction of the grain of the cellulosic material); third, placing both the treated wafer and the control wafer in a conditioning chamber maintained at 65±3% relative humidity and 21±3° C. until a constant weight is achieved; fourth, immersing both the treated wafer and the control wafer in distilled water at 24±3° C. for 30 minutes; and fourth, measuring the tangential dimension of both the treated wafer and the control wafer following removal from the water to provide a post tangential dimension (T₂).

DoN refers to the degree of neutralization of the carboxylic acid functionality in the polymer.

The percent swelling (S) for each individual wafer (both the treated wafer and the control wafer) is calculated as:

$$S ( \% ) = \frac{{T}_{2} - {T}_{1}}{{T}_{1}} \times 100$$

In each of the Examples herein, the percent swelling of the control wafer is 3.0%.

Water-repellency efficiency (WRE) is used to determine the effectiveness of the treating agent in adding water repellant properties to the treated cellulosic material. WRE is calculated as:

$$WRE ( \% ) = \frac{{S}_{1} - {S}_{2}}{{S}_{1}} \times 100$$

S₁ refers to the percent swelling of the untreated wafer; S₂ refers to the percent swelling of the treated wafer. According to E4-11, for most outdoor applications a minimum WRE of 75% is preferred.

The following Examples illustrate certain aspects of the present disclosure, but the scope of the present disclosure is not limited to the following Examples.

### Materials

PEG 1000. PEG 1000 is a commercially available polyethylene glycol available under the trademark CARBOWAX™ from The Dow Chemical Company. It is dissolved in water to give a 30 wt. percent solution.

Alkyd Dispersion. The alkyd is prepared using procedures described in WO2013056162. Components are, by percentage (approximate): Trimethylolpropane (TMP): 28.6; Phthalic anhydride: 32.6; Benzoic acid: 6.3; and Sunflower oil: 32.5. The oil content is 34% in the final resin, hydroxyl value is ca. 96, and Mn is ca. 2100-2200. The aqueous dispersion formulation has the following characteristics: Acid value: 11.5; Oil Length: 34%; Particle Size: 142 nm; Solid Concentration: 51.89%; Neutralization: 90% NH₄OH. The material is diluted with water to 40% solids for the wood treatment. This dispersion is identified below as “Dispersion 1”.

Polyester Dispersion. A polyester dispersion is prepared by setting a Helicone reactor at 90° C. and adding 210 grams of AQ14000 polyester (available as a solid from the Eastman Chemical Company, glass transition temperature of 0° C., melt viscosity of 400,000 cP, and a calculated charge density of 0.32 meg/g). The bowl of the reactor is sealed, pressurized to 70 psi with nitrogen, and the heater set point is increased to 150° C. Once the measured temperature had reached 125° C. the mixer is turned on at max rpm and water is started at 10 ml/min. A total of 810 ml of water is loaded into the batch to give a target % solids of 20%. Once all the water is added the mixing is stopped and the heater set point is lowered to 90° C. When the bowl temperature dropped below 95° C. the pressure on the bowl is released and the dispersion is unloaded from the vessel. The aqueous dispersion had a solid concentration of 20 wt %, and an average particle diameter of 67 nm. This dispersion is identified below as “Dispersion 2”.

Urethane Dispersion. PRIMAL Binder U-51 is a waterborne anionic dispersion of an aliphatic urethane polymer commercially available from the Dow Chemical Company at 34-36% solids. The material is diluted with water to give 25% solids. This dispersion is identified below as “Dispersion 3”.

Cellulosic Dispersion. The ethylcellulose polymers used in the inventive examples are commercially available from The Dow Chemical Company as ETHOCEL™ Standard 10, ETHOCEL™ Standard 20, or ETHOCEL™ Standard 100 with ethyl ether content from 48.0 to 49.5%.

To form the cellulosic dispersion, components land 2 listed in Table I are fed into a 25 mm diameter twin screw extruder using a controlled rate feeder or a positive displacement liquid pump as appropriate at the feed rates in grams/minute (g/min) indicated in Table I. Components 1 and 2 are forwarded through the extruder and melted to form a liquid melt material. The extruder temperature profile is ramped up to the temperature listed in the “Polymer Melt Zone” column of Table II. Water and neutralizing agent are mixed together and fed to the extruder at a rate indicated in Table I (Base/Surfactant) for neutralization at an initial water introduction site. Dilution water is fed into the extruder via a positive displacement pump at the rate indicated in Table II. The extruder speed is 470 rpm as recorded in Table II. At the extruder outlet, a backpressure regulator is used to adjust the pressure inside the extruder barrel to a pressure adapted to reduce steam formation (generally, the pressure is in the range of about 2 MPa to about 4 MPa).

A dispersion product is removed from the extruder. The dispersion is filtered through a 200 micrometer (um) filter. The resultant filtered dispersion had a solids content measured in weight percent (wt %); and the solids particles of the dispersion had a volume mean particle size (Vmean P.S.) measured in microns and recorded in Table II. The solids content of the dispersion is measured using an infrared solids analyzer; and the particle size of the solids particles of the dispersion are measured using a COULTER® LS-230 particle size analyzer (available from Beckman Coulter Corporation). The solids content and the mean particle size (PS) of the solids particles of the dispersion are described in Table II.

TABLE I
Composition and Process Conditions for ETHOCEL
Std. 20 Aqueous Dispersion

| | Component | Component | Initial | Base/ |
|---|---|---|---|---|
| | 1 | 2 | Water | Surfactant |
| | (feed rate | (feed rate | (feed rate | (feed rate |
| Example | in g/min) | in g/min) | in g/min) | in g/min) |
| ETHOCEL | ETHOCEL | Oleic acid | (12.7) | 28% |
| Dispersion | STD 20 | (6.1) | | ammonia |
| | (50.5) | | | (2.1) |

TABLE II
Composition and Process Conditions for Dispersions A and B

| | | Extruder | | | | | |
|---|---|---|---|---|---|---|---|
| | Dilution | Temperature | | | | | Viscosity, |
| | Water | in Polymer | Extruder | | Vmean | | cP |
| | (feed rate in | Melt Zone | Speed | % | P.S. | | (Rv2, 50 |
| Example | g/min) | (° C.) | (rpm) | Solids | (microns) | pH | rpm) |
| ETHOCEL | 140 | 145 | 470 | 27.8% | 0.23 | 8.73 | 73 |
| Dispersion | | | | | | | |

This dispersion is identified below as “Dispersion 4”.

Acrylic Dispersion 1 . AQUASET 1676 is an acrylic emulsion commercially available from the Dow Chemical Company with a solid concentration of 50 wt %. The material is diluted with water to give 44% solids. This dispersion is identified below as “Dispersion 5”.

Acrylic Dispersion 2. RHOPLEX AC-337N is an acrylic emulsion commercially available from the Dow Chemical Company. It is diluted with water to provide a dispersion having 35% solids. This dispersion is identified below as “Dispersion 6”.

Acrylic Dispersion 3. LIPACRYL™ MB-3640 is a 100% acrylic polymer emulsion, commercially available from the Dow Chemical Company. It is diluted with water to provide a dispersion having 25% solids. This dispersion is identified below as “Dispersion 7”.

Wood Treatment. The PEG 1000, as described above, is used to pressure treat eight southern yellow pine blocks. Each wood block (4 cm*2 cm*0.5 cm) is pressed down by a ring in an evacuated Parr reactor for half an hour followed by drawing in 80 ml of the PEG water solution. The reactor is pressurized to 150 psi under nitrogen and maintained for 60 min. The impregnated wood blocks are then placed in an oven in air at 60° C. for 48 h.

One of the treated blocks is withheld from this procedure and used as a control. The remaining seven treated wood blocks are each post-treated using one of the dispersions identified as Dispersions 1 through 7 by first pressing the wood block down by a ring in an evacuated Parr reactor for half an hour followed by drawing in 80 ml of the respective dispersion. The reactor is pressurized to 150 psi under nitrogen and maintained for 60 min. The impregnated wood blocks are then placed in an oven in air at 60° C. for 48 h.

A leaching test is performed by placing each treated wood block in a Soxhlet extractor with deionized water as the solvent. The pressure is adjusted to reflux water at 35° C. The wood is washed in water for 8 hours and then dried in an oven at 60° C. overnight. The dimensional stability of the dried wood is then conducted following the AWPAS E4-11 procedure, with results listed in Table III.

A comparative example is conducted by coating the ninth wood block surface, using Dispersion 3 (PRIMAL Binder U-51) using only a dip method to provide a surface coating.

TABLE III

| | | | Percentage | | Percentage | |
|---|---|---|---|---|---|---|
| | Polymer | modifying | of swelling | WRE | of swelling | WRE |
| Sample | solution | agent | (Initial) | (initial) | (leached) | (leached) |
| Control | PEG 1000 30% | None | 1.1% | 61.9% | 3.9% | −30.1% |
| | water solution | | | | | |
| 1 | PEG 1000 30% | Dispersion 1 | 0.45% | 85.2% | 1.0% | 65.7% |
| | water solution | | | | | |
| 2 | PEG 1000 30% | Dispersion 2 | 0.22% | 92.5% | 1.4% | 53.2% |
| | water solution | | | | | |
| 3 | PEG 1000 30% | Dispersion 3 | 0.6% | 79.9% | 1.7% | 42.1% |
| | water solution | | | | | |
| 4 | PEG 1000 30% | Dispersion 4 | 0.64% | 78.8% | 1.7% | 43.1% |
| | water solution | | | | | |
| 5 | PEG 1000 30% | Dispersion 5 | 0.2% | 93.2% | 1.8% | 37.4% |
| | water solution | | | | | |
| 6 | PEG 1000 30% | Dispersion 6 | 0.52% | 82.8% | 0.96% | 68.1% |
| | water solution | | | | | |
| 7 | PEG 1000 30% | Dispersion 7 | 0.63% | 78.9% | 0.5% | 82.8% |
| | water solution | | | | | |
| Comparative | none | Dispersion 3 | 2.6% | 13.6% | — | — |
| example | | (surface | | | | |
| | | coating) | | | | |

As the table above shows, and without being limited by theory, the use of an aqueous dispersion of a hydrophobic polymer which is used to form a polymer film slows the extraction of the water soluble polyol (e.g., PEG 1000) from the cell wall by water providing a significantly longer period of dimensional stability compared to a one-step treatment with a water soluble polyol. Also, the pressure treatment using the invention treating agents is more effective than the surface coating treating method.

1. A treated cellulosic material comprising:
a cellulosic material having a porous structure defining a plurality of pores, the cellulosic material comprising wood including wood or wood composite materials, at least a portion of the pores containing a treating agent comprising:
a polymer comprising a water soluble polyol; and
a modifying agent comprising a hydrophobic polymer.

2. The treated cellulosic material of claim 1, wherein the water soluble polyol is selected from the group of polyethylene glycol, polyvinyl alcohol, ethylene oxide/propylene oxide copolymer, ethoxylated glycerin, ethoxylated trimethyolpropane or ethoxylated sugars.

3. The treated cellulosic material of claim 1, wherein the hydrophobic polymer is selected from the group of ethyl cellulose, polyolefin, polyacrylate, polyurethane, alkyd or polyester.

4. The treated cellulosic material of claim 1, wherein the water soluble polyol is a polyethylene glycol having an average molecular weight less than 2000.

5. A method for preparing a treated cellulosic material comprising:
(a) providing a cellulosic material;
(b) a first treatment protocol comprising impregnating the cellulosic material with a solution comprising a polymer, the polymer comprising a water soluble polyol; and
(c) a second treatment protocol comprising impregnating the cellulosic material with a modifying agent, the modifying agent comprising a hydrophobic polymer dispersed in an aqueous dispersion.

6. The method of claim 5, wherein the water soluble polyol is selected from the group of polyethylene glycol, polyvinyl alcohol, ethylene oxide/propylene oxide copolymer, ethoxylated glycerin, ethoxylated trimethyolpropane or ethoxylated sugars.

7. The method of claim 5, wherein the hydrophobic polymer is selected from the group of ethyl cellulose, polyolefin, polyacrylate, polyurethane, alkyd or polyester.

8. The method of claim 5, wherein the impregnating of the second treatment protocol is conducted under pressure greater than or lower than ambient.

9. The method of claim 5, wherein the first treatment protocol and the second treatment protocol are performed concurrently.

10. The method of claim 5, further comprising impregnating the cellulosic material with an additive.

11. The method of claim 5, further comprising coating the wood with a sealing agent.
